(19) United States
(12) Patent Application Publication
(10) Pub. No.: US 2026/0233199 A1
(43) Pub. Date: Aug. 13, 2026

(54) Sorbent Material and Method of Making the Same

(71) Applicant: MARMON WATER (SINGAPORE) PTE LTD, Singapore (SG)

(72) Inventors: Ramachandra Swamy, Karnataka (IN); Mallikarjuna Shroff Rama, Karnataka (IN); Indumathi Ramakrishnan, Karnataka (IN)

(21) Appl. No.: 19/151,912

(22) PCT Filed: Apr. 26, 2023
(86) PCT No.: PCT/IB2023/054284

§ 371 Date: Jul. 29, 2025

(30) Foreign Application Priority Data
Feb. 20, 2023 (IN) 202321011462

(51) Int. Cl. B01J 20/30; B01J 20/20; B01J 20/22; B01J 20/28; B01J 20/32; C02F 1/28; C02F 101/34; C02F 101/36

(52) U.S. Cl. CPC B01J 20/3085; B01J 20/20; B01J 20/22; B01J 20/28064; B01J 20/28066; B01J 20/3078; B01J 20/3204; B01J 20/3214; B01J 20/3248; C02F 1/285; C02F 1/288; C02F 1/283; C02F 2101/34; C02F 2101/36; C02F 2201/006

(57) ABSTRACT

A surfactant containing activated carbon-based media for efficient removal of volatile organic compounds (VOCs) from water and air. The media is prepared by treating porous activated carbon with an oxidizing agent to render oxidized activated carbon, which is then soaked in a surfactant containing solution. The surfactant impregnates into the pores and on surfaces of the oxidized activated carbon to render surfactant impregnated activated carbon that is capable of enhancing reduction of VOCs. The surfactant impregnated activated carbon media may be made into filter blocks or provided into filter cartridges.

### BACKGROUND OF THE INVENTION

### 1. Field of the Invention

The present invention relates generally to removal of volatile organic compounds and, more particularly, to methods of making carbon media, the resultant carbon media, and methods of removing volatile organic compounds from drinking water and air using said carbon media.

### 2. Description of Related Art

Volatile organic compounds (VOCs) are organic compounds that are known to contaminant drinking water and air. VOCs are EPA-regulated contaminants having very low boiling points that readily turn into gases and vapors at both ambient and below freezing temperatures. VOCs are present in a wide variety of commercial, industrial, and residential products including, for instance, gasoline, paints, solvents, glue and adhesives, ink, magic marker pens, pesticides, and various common household products. They typically find their way into drinking water supplies through accidental spills, storm water runoff, as well as by careless handling and improper disposal of by humans. VOCs are widely used and, as such, are abundant in both the atmosphere and water. While airborne VOCs can usually be detected by their distinctive odors, VOCs in water are not so easy detected.

While a variety of different VOCs are present in water supplies, the following three (3) contaminants are most prevalent: Trihalomethane; Perchloroethylene; and Methyl tert-butyl ether. Trihalomethane (THM) is the most common VOC found in drinking water. It is a byproduct of water disinfection by municipal water treatment plants treating water sourced from rivers and lakes, as well as by private well owners. This byproduct is a result of chlorine added to the water to kill pathogens reacting with organic matter in the water and forming the THM. Perchloroethylene (PCE) is a byproduct from industrial solvents, such as, dry-cleaning products and degreasing agents. It is also found in consumer products like shoe polish and solvents for diluting or breaking down inks. Methyl tert-butyl ether (MTBE) is an extensively used fuel additive added to lead-free gasoline to increase the octane levels. Due to spillage and leaking underground storage tanks contaminating soil and groundwater, MTBE is another drinking water contaminate.

Removal of VOCs from drinking water is essential as they can have adverse health effects including eyes, nose, and throat irritation; headaches; loss of coordination and nausea. Long term exposure to VOCs can result in liver and kidney damage, impairment of the central nervous system, and it is believed that prolonged exposure to VOCs may cause cancer. Various treatment technologies exist for removal of VOCs from drinking water. The most common VOC removal techniques include carbon filtration and reverse osmosis filtration couple with a carbon filter. While reverse osmosis drinking water treatment systems cannot remove VOCs, which will pass through the membrane, most are fitted with a carbon pre-filter or post-filter for removal of VOCs.

The most effective way of removing VOCs from drinking water is through carbon filtration. In carbon filtration an activated carbon filter cartridge absorbs organic compounds, taste and odor compounds, as well as VOCs in drinking water. Since VOCs are organic carbon-based compounds, the adsorption properties of the activated carbon attract and capture the VOCs in pores of the activated carbon as they pass through the filter. While many carbon filters trap most of the VOCs in the carbon pores, there can still be unacceptable amounts of VOCs output after filtration. Further, it has been found that some VOCs such as, trihalomethanes, are very difficult to control and remove from drinking water as well as air.

Over the years prior art has focused on enhancing the ability of carbon filters to remove VOCs. For instance, techniques have been developed to treat activated carbon with organic solid compounds, such as, esterified pullulan and esterified gluconans, to render hydrophobic modified activated carbon for removal of organohalogen compounds from air (see, e.g., Japanese Patent Pub. JPH04171043A). Other approaches for hydrophobically modifying the surface of activated carbon include treatment with chloroalkyl silanes for removal of volatile organochlorines, or treatment with chloroalkyl silanes on activated carbon for removal of volatile organochlorine compounds (see, e.g., U.S. Pat. No. 5,837,644). Surface acid treatment of carbon, without a prior oxidation step, has also been taught to enhance hydrophobic VOC removal.

However, each of these known approaches has its limits, and may not remove all VOCs. Further, some known approaches require a large quantities of treated carbon media due to larger sized filter cartridges, which provides more media for VOC removal. With current trends and designs in home VOC treatment systems reducing in size to fit or accommodate smaller areas, improvements in treated carbon media are needed that enable smaller amounts of media in smaller cartridges to effectively and efficiently remove VOCs from water and air. Accordingly, further improvements are needed for new and improved methods of treating activated carbon and the resultant treated activated carbon media that increases removal of VOCs for which the present invention provides a solution thereto.

### SUMMARY OF THE INVENTION

Bearing in mind the problems and deficiencies of the prior art, it is therefore an object of the present invention to provide methods of treating activated carbon for enhanced removal of VOCs from water and/or air.

Another object of the present invention is to provide treated activated carbon having enhanced capabilities for removal of VOCs from water and/or air.

It is another object of the present invention to provide methods of removing increased amounts of VOCs and/or difficult to remove VOCs from water and/or air using the various treated activated carbon media of the invention.

Other objects of the invention are to provide methods of treating activated carbon, the resultant treated activated carbon, and methods of removing VOCS from water/air in a cost effective and efficient manner.

Still other objects and advantages of the invention will in part be obvious and will in part be apparent from the specification.

The above and other objects, which will be apparent to those skilled in the art, are achieved in the present invention which is directed to methods of fabricating treated sorbent material that removes volatile organic compounds (VOCs) from water and air by providing porous activated carbon and treating it with an oxidizing agent to render oxidized activated carbon. The oxidized activated carbon is then soaked in a surfactant containing solution, whereby the surfactant impregnates into the pores and on surfaces of the oxidized activated carbon.

The weight percentage of the surfactant concentration in solution with respect to weight of the oxidized activated carbon on dry basis ranges from 0.005 wt. % to 2 wt. %. The impregnated activated carbon is then separated from the surfactant containing solution and dried to render surfactant impregnated activated carbon that is capable of enhancing reduction of VOCs.

The present invention is also directed method of fabricating treated sorbent material that removes volatile organic compounds (VOCs) from water and air by providing porous activated carbon and treating it with a phosphoric acid solution having a concentration ranging from about 1.0% v/v to about 1.6% v/v, draining, and then soaking the oxidized activated carbon in a DTAB or a lecithin surfactant containing solution. The DTAB or lecithin impregnates into the pores and on surfaces of the oxidized activated carbon. The weight percentage of the DTAB or lecithin surfactant concentration in solution with respect to weight of the oxidized activated carbon on dry basis ranges from 0.01% w/w to about 0.5% w/w. The impregnated activated carbon is then separated from the DTAB or lecithin surfactant containing solution and dried to render DTAB or lecithin surfactant impregnated activated carbon that is capable of enhancing reduction of VOCs.

Still further, the invention is directed to adsorbent activated carbon media comprising surfactant impregnated activated carbon having surfactant trapped at least within pores of the activated carbon. As a contaminated source runs through the adsorbent, the surfactant attracts and removes volatile organic compounds (VOCs) from the contaminated source. In one or more embodiments the impregnated surfactant on the adsorbent activated carbon media may be DTAB or lecithin.

The present invention is also directed to filter blocks comprising a binder material and surfactant impregnated activated carbon having surfactant trapped at least within pores of the activated carbon, wherein as a contaminated source runs through the filter block, the surfactant attracts and removes volatile organic compounds (VOCs) from said contaminated source. In these filter blocks the impregnated surfactant in the pores and on surface of the activated carbon may be DTAB or lecithin for removal of VOCs.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the description of the preferred embodiment(s), which follows, taken in conjunction with the accompanying drawings of the invention in which:

FIG. 1 is a graphical comparative representation of VOC removal of surfactant impregnated activated carbon of Examples 8 and 9 of the invention, as compared to non-surfactant treated oxidized carbon (Example 6).

FIG. 2 is a graphical representation for chloroform removal using filter blocks of the invention.

FIG. 3 is another graphical representation for MTBE removal using filter blocks of the invention.

### DESCRIPTION OF THE PREFERRED EMBODIMENT(S)

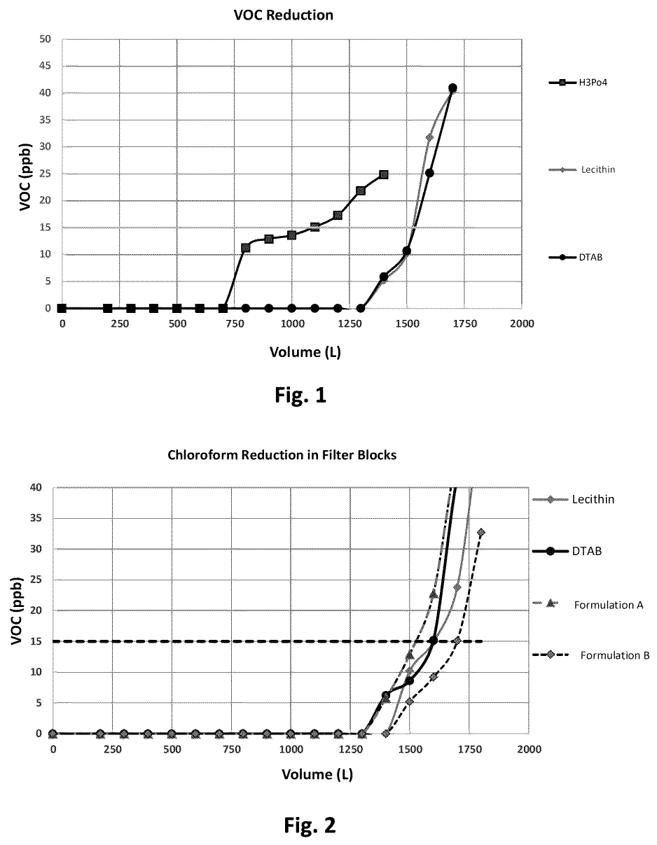

In describing the preferred embodiment of the present invention, reference will be made herein to FIGS. 1-3 of the drawings in which like numerals refer to like features of the invention. The embodiments of the present invention can comprise, consist of, and consist essentially of the features and/or steps described herein, as well as any of the additional or optional ingredients, components, steps, or limitations described herein or would otherwise be appreciated by one of skills in the art.

In accordance with the invention, one or more embodiments are directed to methods of making surfactant impregnated activated carbon and the resultant surfactant-containing carbon. The surfactant impregnated activated carbon materials of the invention are capable of significantly reducing and/or entirely removing volatile organic compounds (VOCs) from water and/or air. Suitable starting material of the invention comprises activated carbon including, but not limited to, coconut-based carbon, wood-based carbon, nutshell-based carbon, lignite-based carbon, coal-based carbon, fiber-based carbon, and the like. Suitable porous activated carbon has a high surface area for increased capacity, particularly greater than 500 m2/g, and preferably ranging from about greater than 800 m2/g to 1600 m2/g, as measured by nitrogen adsorption methodology. In one or more preferred embodiments, the porous activated carbon has a surface area ranging from about 900 m2/g to 1250 m2/g.

The activated carbon may be a powdered activated carbon (PAC) having a particle size between 0.045 and 0.180 mm, as defined by ASTM Fine mesh. Alternatively, the activated carbon may be a granular activated carbon (GAC) having a particle size between 0.4-1.2 mm. In one or more preferred embodiments, the activated carbon preferably has a high surface area such as, for example, about 1000 m2/g (based on Brunauer Emmet Teller (BET) nitrogen adsorption methodology). By selecting activated carbon materials having high surface area, the porosity thereof is also increased which provides a larger pore surface area available for adsorption of surfactant.

The present methods include pre-treating the activated carbon material to render oxidized activated carbon. This may be accomplished by using an oxidizing acid solution to render acid washed oxidized activated carbon. In one or more embodiments, the porous activated carbon is soaked in an aqueous acidic slurry for 5 minutes, preferably at least for 30 minutes, and more preferably from about 2 to 4 hours, or more, to render acid washed oxidized activated carbon. The aqueous acidic slurry may be a solution containing phosphoric acid, orthophosphoric acid, sulfuric acid, hydrochloric acid, nitric acid, any other known oxidizing acid, as well as combinations thereof. For instance, in certain embodiments the aqueous slurry may be a phosphoric acid solution 1.0-2.0% volume/volume (v/v) concentration, an orthophosphoric acid solution 0.1-2.5% weight/volume (w/v) concentration, a sulfuric acid solution 1.0% v/v concentration, a hydrochloric acid solution 1.0% v/v concentration, or a nitric acid solution 1.0% v/v concentration. In other embodiments, the porous activated carbon is soaked in an aqueous slurry for 5 minutes to 4 hours, or more, to render oxidized activated carbon.

In other embodiments, activated carbon is soaked in an aqueous solution containing oxidizing agents to render the oxidized activated carbon. The aqueous oxidizing agent slurry may be a solution containing ammonium persulfate such as, for example, an ammonium persulfate solution 1.0% w/v concentration. The oxidized activated carbon may also be obtained by heating carbon in a partial oxygen atmosphere to render oxidized activated carbon having carboxylate groups on the surface thereof. Steam heating of carbon may also be implemented to render the oxidized activated carbon.

In embodiments using aqueous slurries or solutions to render the oxidized activated carbon, the aqueous phase is drained to isolate the oxidized activated carbon. In one or more embodiments, the isolated oxidized activated carbon may be further processed in its current wet state, or alternatively it may be dried prior to further processing. Drying of the wet isolated oxidized activated carbon may be performed at a temperature above 50° C., preferably from about 80° C. to 120° C., most preferably from about 100° C. to 110° C., until a final moisture content of the oxidized activated carbon is less than 20 wt %, preferably less than 10 wt %, and most preferably less than 5 wt %, based on a total weight of the oxidized activated carbon itself in its dry state. Suitable drying devices include, for instance, carrying out drying within a tunnel drier, oven drier, or fluidized bed drier. In one or more preferred embodiments, the activated carbon is soaked in an acid solution of orthophosphoric acid solution 0.1-2.5% weight/volume (w/v) concentration for about 2 hours, followed by drying at a temperature from about 100° C. to 110° C.

The oxidized activated carbon, in either a wet state or dried state, is then soaked in an aqueous solution containing a surfactant present in an amount ranging from about 0.005% to 2% weight/weight (w/w) concentration, preferably from about 0.01% to 0.5% w/w, wherein weight percent of surfactant is based on the total weight of the oxidized activated carbon being treated in a dry state.

The oxidized activated carbon is soaked in the surfactant containing solution for a time sufficient for allowing the surfactant to impregnate into pores of the oxidized activated carbon and be trapped therein. In one or more embodiments, the oxidized activated carbon is soaked in the surfactant containing solution for a period of at least 5 minutes, preferably at least 30 minutes to 1 hour, and more preferably from at least 2 to 4 hours. The time of the soak may vary so long as the duration is suitable to enable and ensure maximum adsorption of surfactant to the oxidized activated carbon. In one or more embodiments, this soak step may be performed at ambient temperature, or alternatively, heat may be applied.

In accordance with the invention, the surfactant may be a cationic surfactant, anionic surfactant, zwitterionic surfactant, a non-ionic surfactant, or combinations thereof. In those embodiments where the surfactant is a cationic surfactant, it may comprise alkylammonium compounds, alkyl phosphonium compounds, long chain quaternary ammonium salts, or phosphonium salts. In embodiments where the surfactant is an anionic surfactant, it may be materials including alkyl carboxylates or sulfonates. The surfactant may also be a zwitterionic surfactant, such as, phopahtidylcholine, lysine, or arginine. In other embodiments, the surfactant may be a non-ionic surfactant, such as, alkylethoxylates. In one or more preferred embodiments, the surfactant may be dodecyl trimethyl ammonium bromide (DTAB) or lecithin, present in the solution in an amount ranging from about 0.01%-0.5% w/w concentration.

The soaked impregnated activated carbon is separated (e.g., by filtration) from the surfactant containing solution, and then dried to render surfactant impregnated activated carbon having surfactant material trapped within carbon pores. The surfactant may also reside on the outer exposed surface area of the carbon material. In accordance with the invention, the surfactant impregnated activated carbon particles may be dried until about 10 wt. % to 15 wt. % of moisture remains on such particles, or even less moisture content (i.e., less than 5 wt. %.). The surfactant impregnated carbon is dried so that the fully or partially dried surfactant impregnated activated carbon particles may be incorporated in, or made into, a filtration block for filtering organic contaminants from water and/or air. The drying step also helps in storage of the surfactant impregnated activated carbon particles.

In one or more embodiments the surfactant impregnated activated carbon (sorbent material) may be formed into a block (filter block) for the enhancing reduction and/or removal of VOCs as well as multiple other contaminants from water/air. It has been found that the final dried surfactant impregnated activated carbon sorbent material provides significantly improved capacity for VOC removal from drinking water, as compared to prior art and known sorbent materials not containing a surfactant material. In accordance with the invention, the combined oxidation step, followed by the step of treating the oxidized carbon with a low concentration of surfactant, maximizes the removal of VOCs. It has been found that when carbon surfaces are too hydrophobic, downstream bonding to such surfaces is minimal, if not impossible. In the invention, the oxidation step reduces the hydrophobicity of the carbon surfaces and enhances absorption of the surfactant (e.g. surfactant containing cationic groups) onto the oxidized activated carbon (i.e., into pores and on surfaces thereof).

When surfactant impregnated activated carbon sorbent material of the invention is included in, or made into, a filter (e.g., filter cartridge) or filter block, VOCs in drinking water/air are reduced or removed by filtering such contaminated water/air through the present filters/filter blocks, whereby VOCs adhere to the surfactant-containing carbon sorbent material of the invention and clean water/air is discharged. Spent filters/filter blocks containing the contaminants adhered to the surfactant-containing carbon sorbent material can either be disposed of or repurposed by removing and adding new surfactant-containing carbon sorbent material of the invention. The efficiency and effectiveness of the present surfactant impregnated activated carbon sorbent material in removing multiple contaminants in small quantities of sorbent material also renders the present media suitable for use in, or making into, smaller carbon filtration blocks, which in turn, reduces the carbon footprint as well as costs.

The resultant surfactant impregnated activated carbon of the invention may be used to remove various organic contaminants from water and/or air. For instance, various surfactant impregnated activated carbon of the invention are capable of removing a variety of VOCs from drinking water as well as air. These VOCs include, but are not limited to, trihalomethanes (THMs) (particularly, chloroform), methyl tert-butyl ethers (MTBEs), perchloroethylenes (PCEs), Trichloroethylenes (TCEs), methylene chloride-dichloromethane (DCM), methylene chloride, carbon tetrachloride, vinyl chloride, chloroform, trichloromethane, dichloroethane, dichloromethane, benzene, ethylbenzene, tetrachloroethylene, trichloroethylene, dichloropropane, trichloropropane, toluene, xylenes, styrene, and dioxane. It should be appreciated that trihalomethanes are a group of four chemicals (chloroform, bromodichloromethane, dibromochloromethane, and bromoform) formed when chlorine or other disinfectants used to control microbial contaminants in drinking water react with naturally occurring methane derived from organic and inorganic matter in water. The present surfactant impregnated activated carbon are also capable of removing perfluoroalkyl compounds (e.g., perfluoro alkyl carboxylates), semi volatile organic compounds, organic pharmaceutical contaminants, sulfonates, bisphenol A, and phthalates from water and/or air.

While not meant to be limiting, Tables 1-3 demonstrate the enhanced results of surfactant impregnated activated carbon of the invention. Referring to Examples 1-7 in Tables 1 and 2 below, activate carbon was single-step treated only with an oxidation step using an oxidizing wash, and then formed into water filtration blocks of 82 g. The filter block was made of 70 wt % oxidized activated carbon and 30 wt. % binder material. Suitable binder material includes, but is not limited to, polymers including polyethylenes, polyamides, polyvinyline fluoride or any other material that can bind the carbon into a block while providing structural stability thereto, without contaminating drinking water. Performance tests to measure removal of VOC, particularly, chloroform (CHCl3) were performed on Examples 1-7. In these VOC performance reduction testing (per NSF/ANSI 53 protocol), the input water had a chloroform concentration of 300±30 ppb while the output should have less than 15 ppb of chloroform. The flow rate was maintained at 2 liters per minute. The results are shown in Tables 1 and 2.

Referring to Table 1, in accordance with one or more embodiments of the invention it was found activated carbon oxidized using an acid washing agent comprising phosphoric acid exhibited the most removal of chloroform. That is, the filtration block made with phosphoric acid treated oxidized carbon exhibited better performance than other oxidizing treatments among Examples 1 to 4.

TABLE 1
Examples 1 to 4

| | | | Volume capacity |
|---|---|---|---|
| | | | in liters (L) that |
| | | | passed with <15 ppb |
| | Stage1: | | CHCl3 in the out- |
| | Only | Weight of | put water while the |
| | oxidation | filtration | input water@ |
| Ex. No. | treatment | block, g | 300 ppb CHCl3 |
| 1 | Sulfuric acid | 82 g | 400 L |
| | 1.0% v/v | | |
| 2 | conc. | 82 g | 300 L |
| | hydrochloric acid | | |
| | 1.0% v/v | | |
| 3 | ammonium | 82 g | 300 L |
| | persulfate | | |
| | 1.0% w/v | | |
| 4 | phosphoric acid | 82 g | 650 L |
| | 1.0% v/v | | |

In these embodiments, oxidation using a phosphoric acid wash was further tested to identify one or more preferred wash concentrations that avoid deleteriously affecting carbon pH. Referring to Table 2, Examples 4 to 7 show these performance tests of oxidized carbon obtained by treatment with varying concentrations of phosphoric acid, followed by fabrication into filtration blocks for performance evaluation. With surface water systems having a pH ranging from about 6.0 to 8.5 for carbon treatment, the carbon pH for treatment is ideally similar (e.g., pH of at least 6.0 to 6.5). It was found that treatment with a phosphoric acid solution at a concentration ranging from about 1.0% v/v to about 1.5% v/v (Examples 5 and 6), with slight variations above and below such pHs, exhibited the most chloroform removal (i.e., 650 L and 700 L, respectively) of the tested pH ranges in Table 2. These concentrations of phosphoric acid wash solutions also maintained the carbon pH.

TABLE 2
Examples 4 to 7

| | | | Volume capacity | |
|---|---|---|---|---|
| | | | in liters (L) that | |
| | | | passed with <15 ppb | |
| | Stage1: | | CHCl3 in the out- | pH of |
| | Only | weight of | put water while the | the |
| | oxidation | filtration | input water@ | treated |
| Ex. No. | treatment | block, g | 300 ppb CHCl3 | carbon |
| 4 | phosphoric acid | 82 g | 450 L | 7.6 |
| | 0.5% v/v | | | |
| 5 | phosphoric acid | 82 g | 650 L | 6.4 |
| | 1.0% v/v | | | |
| 6 | phosphoric acid | 82 g | 700 L | 6.2 |
| | 1.5% v/v | | | |
| 7 | phosphoric acid | 82 g | 900 L | 4.2 |
| | 2.0% v/v | | | |

In accordance with the invention, activated carbon was first oxidized using a phosphoric acid wash, the oxidized activated carbon was isolated (e.g., by rinse/draining), and then treated with a surfactant containing solution. In one or more embodiments, Table 3 shows one or more embodiments of the invention whereby activated carbon was treated in a first step with a 1.6% v/v phosphoric acid solution, drained, and then treated in a second-step with a surfactant containing solution. In Example 8 the oxidized activated carbon was treated with dodecyl trimethylammonium bromide (DTAB) surfactant, while the Example 9 oxidized activated carbon was treated with lecithin surfactant. The DTAB and lecithin surfactants absorbed into pores and/or on surfaces of the oxidized activated carbon to render surfactant impregnated activated carbon. The surfactant impregnated activated carbon of Examples 8 and 9 were formed into filter blocks, which were then performance tested for removal of VOCs from drinking water.

TABLE 3
Examples 8 and 9 of the invention

| | | | | Volume capacity |
|---|---|---|---|---|
| | | | | in liters (L) that |
| | | | | passed with <15 ppb |
| | Stage1: | | | CHCl3 in the out- |
| | Oxidation/ | Stage2: | weight of | put water while the |
| | acid | Surfactant | Filtration | input water@ |
| Ex. No. | treatment | treatment | block, g | 300 ppb CHCl3 |
| 8 | phosphoric acid | DTAB | 130 g | 1500 L |
| | ~1.6% v/v | 0.125% w/w | | |
| 9 | phosphoric acid | lecithin | 130 g | 1500 L |
| | ~1.6% v/v | 0.05% w/w | | |

Referring to Tables 4 and 5 below, oxidized activated carbon were treated with various concentrations of DTAB and lecithin solutions in concentrations ranging from 0.01-0.5% w/w for about 1 hour. After filtering off the excess surfactant containing solution, the surfactant impregnated carbon was dried (e.g., in a tunnel drier or oven) at a temperature from about 100° C. to 110° C. until the moisture content becomes less than 5 wt. %. It was found that concentrations of DTAB ranging from about 0.05% w/w to about 0.125% w/w exhibited enhanced VOC (i.e., chloroform) removal from water passing through the respective filters. Again, % w/w refers to weight of DTAB to weight of oxidized activated carbon. In one or more embodiments, DTAB at concentrations from about 0.1% w/w to about 0.125% w/w exhibited optimal VOC removal, while in other embodiments lecithin at concentrations from about 0.1% w/w to about 0.125% w/w exhibited optimal VOC removal.

Table 4 shows various concentrations of DTAB treatment tested in deriving to Example 8, and their respective reduction capacity for chloroform as per NSF standard.

TABLE 4
Various DTAB concentrations tested in deriving Example 8*

| | Chloroform |
|---|---|
| DTAB % | reduction |
| Treatment | capacity, L |
| 0.025 | 800 |
| 0.05 | 1000 |
| 0.1 | 1200 |
| *0.125 | 1500 |
| (Ex. 8) | |
| 0.25 | 800 |
| 0.5 | 700 |

Table 5 shows various concentrations of lecithin treatment tested in deriving to Example 9, and their respective reduction capacity for chloroform as per NSF standard.

TABLE 5
Various Lecithin concentrations tested in deriving Example 9*

| | Chloroform |
|---|---|
| Lecithin % | reduction |
| Treatment | capacity, L |
| 0.025 | 800 |
| *0.05 | 1500 |
| (Ex. 9) | |
| 0.1 | 1500 |
| 0.125 | 1500 |
| 0.25 | 900 |
| 0.5 | 800 |

In accordance with the invention, it was found that the filters of the invention in Examples 8 and 9 exhibited optimal or enhanced VOC reduction as compared to Examples 1 to 7.

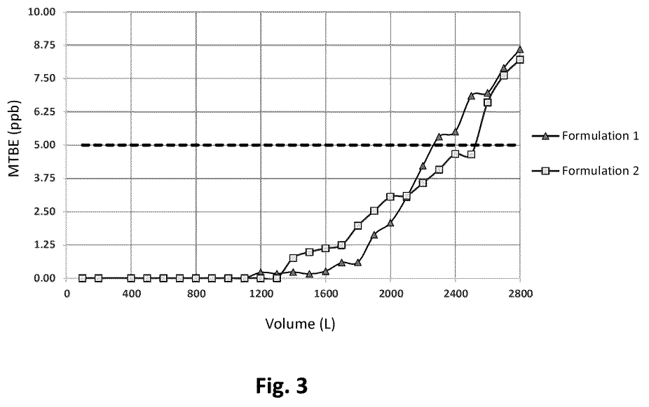

Referring to the drawings, FIG. 1 depicts a graphical plot of Example 6 as compared to Examples 8 and 9 of the invention. As shown, the DTAB and lecithin surfactant impregnated activated carbon filters of Examples 8 and 9 significantly increased VOC removal from the filtered water, as compared to the reduced amount of VOC removal in Example 6 (a filter made of oxidized carbon obtained by phosphoric acid (H3PO4) treatment alone). FIGS. 2 and 3 respectively show graphical representations of VOC removal of chloroform (FIG. 2) and MTBE (FIG. 3) using filter blocks of the invention.

It should be appreciated that while the experimental results in the examples were tested for chloroform and MTBE removal from water (both of which are difficult to remove), the present surfactant-containing activated carbon sorbent media of the invention is capable of removing various VOCs and organic matter. The surfactant-containing activated carbon sorbent media of the invention is also suitable for use in air filters for the removal of VOCs. Further, in those embodiments of the invention that implement a cationic surfactant, the resultant surfactant-containing activated carbon sorbent media of the invention has the additional advantageous capacity of removing anionic compounds like PFAS/PFOS and other emerging contaminants from the list of perfluoro alkyl carboxylates and sulfonates.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of fabricating treated sorbent material that removes volatile organic compounds (VOCs) from water and air comprising:
providing porous activated carbon;
treating the porous activated carbon with an oxidizing agent to render oxidized activated carbon;
soaking the oxidized activated carbon in a surfactant containing solution, wherein the surfactant is selected from the group consisting of alkylammonium compounds, alkyl phosphonium compounds, long chain quaternary ammonium salts, phosphonium salts, phopahtidylcholine, lysine, arginine, alkylethoxylates, dodecyl trimethyl ammonium bromide (DTAB), and lecithin;
impregnating the surfactant into pores and on surfaces of the oxidized activated carbon, whereby weight percentage of the surfactant concentration in solution with respect to weight of the oxidized activated carbon on dry basis ranges from 0.005 wt. % to 2 wt. %;
separating the soaked impregnated activated carbon from the surfactant containing solution; and
drying the soaked impregnated activated carbon to render surfactant impregnated activated carbon having the surfactant trapped within the pores thereof, the surfactant impregnated activated carbon capable of enhancing reduction of VOCs.

2. The method of claim 1 wherein the porous activated carbon comprises powdered activated carbon or activated carbon.

3. (canceled)

4. The method of claim 1 wherein the porous activated carbon is selected from the group consisting of coconut-based carbon, wood-based carbon, nutshell-based carbon, lignite-based carbon, coal-based carbon, and fiber-based carbon.

5. The method of claim 1 wherein the porous activated carbon has a high surface area ranging from about 800 m2/g to about 1600 m2/g, as measured by nitrogen adsorption methodology.

6. The method of claim 1 wherein the oxidizing agent is selected from the group consisting of a heated oxygen atmosphere, an aqueous solution containing ammonium persulfate, or an acid wash comprising an aqueous slurry to render the oxidized activated carbon.

7.-16. (canceled)

17. The method of claim 6 wherein the oxidizing agent is the acid wash comprising the aqueous slurry, the method further comprising:
draining the aqueous slurry to isolate the oxidized activated carbon; and
drying the oxidized activated carbon at a temperature above 50° C. until a final moisture content becomes less than 15 wt % based on a total weight of the oxidized activated carbon being dried.

18.-24. (canceled)

25. The method of claim 1 wherein the surfactant is the DTAB present in an amount ranging from about 0.01-0.5% w/w concentration.

26. (canceled)

27. The method of claim 1 wherein the surfactant is the lecithin present in an amount ranging from about 0.01-0.5% w/w concentration.

28. (canceled)

29. The method of claim 1 wherein the surfactant impregnated activated carbon further resides on surfaces of the carbon.

30. The method of claim 1 wherein the surfactant impregnated activated carbon removes VOCs selected from the group consisting of chloroform, perfluoroalkyl compounds (e.g., perfluoro alkyl carboxylates), semi volatile organic compounds, organic pharmaceutical contaminants, sulfonates, and other organic compounds like bisphenol A, phthalates.

31. The method of claim 1 further including fabricating a filter block using the surfactant impregnated activated carbon and filtering a contaminated drinking water or air source using said filter block.

32. The method of claim 1 further including providing the surfactant impregnated activated carbon in a filter cartridge and filtering a contaminated drinking water or air source using said filter cartridge.

33. (canceled)

34. A method of fabricating treated sorbent material that removes volatile organic compounds (VOCs) from water and air comprising:
providing porous activated carbon;
treating the porous activated carbon with a phosphoric acid solution having a concentration ranging from about 1.0% v/v to about 1.6% v/v;
draining the phosphoric acid solution to render oxidized activated carbon;
soaking the oxidized activated carbon in a dodecyl trimethylammonium bromide (DTAB) surfactant containing solution;
impregnating the DTAB into pores and on surfaces of the oxidized activated carbon, whereby weight percentage of the DTAB concentration in solution with respect to weight of the oxidized activated carbon on dry basis ranges from about 0.01% w/w to about 0.5% w/w;
separating the soaked impregnated activated carbon from the DTAB containing solution; and
drying the soaked impregnated activated carbon to render DTAB impregnated activated carbon having the DTAB trapped at least within the pores thereof, the DTAB impregnated activated carbon capable of removing VOCs from a contaminated source.

35. The method of claim 34 wherein the DTAB concentration in solution ranges from about 0.1% w/w to about 0.125% w/w.

36. A method of fabricating treated sorbent material that removes volatile organic compounds (VOCs) from water and air comprising:
providing porous activated carbon;
treating the porous activated carbon with a phosphoric acid solution having a concentration ranging from about 1.0% v/v to about 1.6% v/v;
draining the phosphoric acid solution to render oxidized activated carbon;
soaking the oxidized activated carbon in a lecithin surfactant containing solution;
impregnating the lecithin into pores and on surfaces of the oxidized activated carbon, whereby weight percentage of the lecithin concentration in solution with respect to weight of the oxidized activated carbon on dry basis ranges from about 0.01% w/w to about 0.5% w/w;
separating the soaked impregnated activated carbon from the lecithin containing solution; and
drying the soaked impregnated activated carbon to render lecithin impregnated activated carbon having the lecithin trapped at least within the pores thereof, the lecithin impregnated activated carbon capable of removing VOCs from a contaminated source.

37. The method of claim 34 wherein the lecithin concentration in solution ranges from about 0.1% w/w to about 0.125% w/w.

38. The method of claim 34 or 36 further comprising drying the oxidized activated carbon at a temperature above 50° C. until a final moisture content becomes less than 15 wt % based on a total weight of the oxidized activated carbon being dried prior to treating the oxidized activated carbon with the DTAB.

39. The method of claim 34 or 36 wherein the VOCs are selected from the group consisting of chloroform, MTBE, perfluoroalkyl compounds (e.g., perfluoro alkyl carboxylates), semi volatile organic compounds, organic pharmaceutical contaminants, sulfonates, and other organic compounds like bisphenol A, phthalates.

40.-45. (canceled)
